(19) United States
(12) Patent Application Publication
(10) Pub. No.: US 2021/0092158 A1
(43) Pub. Date: Mar. 25, 2021

(54) METHOD, APPARATUS, DEVICE, TERMINAL, AND MEDIUM FOR DEFENDING AGAINST ATTACKING BEHAVIOR

(71) Applicant: Baidu Online Network Technology (Beijing) Co., Ltd., Beijing (CN)

(72) Inventors: Wanli ZHAO, Beijing (CN); Huagou QIAN, Beijing (CN)

(21) Appl. No.: 16/809,394

(22) Filed: Mar. 4, 2020

(30) Foreign Application Priority Data
Sep. 20, 2019 (CN) 201910893777.8

(51) Int. Cl. H04L 29/06; H04L 29/12

(52) U.S. Cl. CPC H04L 63/20; H04L 63/1433; H04L 63/0876; H04L 61/1511; H04L 63/1416

(57) ABSTRACT

A method, applied to defensive node devices, and the number of defensive node devices being at least two, includes: receiving a signaling request sent by a terminal provided with an APP, the signaling request being used for requesting for establishing a trusted connection with the defensive node devices, and the signaling request at least including information of the terminal and the APP; authenticating the terminal based on the information of the terminal and the APP, establishing, in response to the authenticating the terminal being successful, the trusted connection with the terminal, and forwarding APP traffic from the terminal to a source station of the APP; and returning a dispatching instruction to the terminal, the dispatching instruction being used for instructing a defensive node device to which the terminal sends the signaling request a next time.

### CROSS-REFERENCE TO RELATED APPLICATIONS

This application claims priority to Chinese Patent Application No. 201910893777.8, filed on Sep. 20, 2019, titled “Method, apparatus, device, terminal, and medium for defending against attacking behavior,” which is hereby incorporated by reference in its entirety.

### TECHNICAL FIELD

The present disclosure relates to the field of Internet technology, specifically relates to an information security technology, and more specifically relates to a method, apparatus, device, terminal, and medium for defending against an attacking behavior.

### BACKGROUND

With the rapid development of the Internet, the cybersecurity also appears to be particularly important. In recent years, cyberattack events have occurred frequently. The cyberattack refers to an attack on systems and resources based on loopholes and security defects of the network information system. For example, a CC (Challenge Collapsar) attack means to simulate a large number of users continuously accessing pages that need to consume a lot of server resources, and exhaust server resources, such that a server is in a state of always having endless to-be-processed requests for a long time, and the server cannot serve normal requests.

At present, defense is usually performed by limiting a concurrency number or banning a large number of highly concurrent requests for similar features. However, for the method of limiting the concurrency number, although the server stability can be ensured, at present, an APP uses a shared IP or a mobile base station, and if directly banning is implemented, it is easy to pass attacking requests and intercept real users. For the method of banning highly concurrent requests, due to different services, if the URL access frequency is limited, then it is easy to affect the services, and banning an IP of a high-frequency URL request is also caused by many cases of using the shared IP or the mobile base station due to the specificity of an APP service access source, thereby resulting in erroneous defense against normal users.

### SUMMARY

A method, apparatus, device, terminal, and medium for defending against an attacking behavior provided by embodiments of the present disclosure may improve the security and effectiveness of defense when defending against cyberattacks.

An embodiment of the present disclosure provides a method for defending against an attacking behavior, the method being applied to defensive node devices, and a number of the defensive node devices being at least two, the method including: receiving a signaling request sent by a terminal provided with an APP, the signaling request being used for requesting for establishing a trusted connection with the defensive node devices, and the signaling request at least including information of the terminal and the APP; authenticating the terminal based on the information of the terminal and the APP, establishing, in response to the authenticating the terminal being successful, the trusted connection with the terminal, and forwarding APP traffic from the terminal to a source station of the APP; and returning a dispatching instruction to the terminal, the dispatching instruction being used for instructing a defensive node device to which the terminal sends the signaling request a next time.

The above embodiments have the following advantages or beneficial effects: the terminal and the APP are authenticated by defensive nodes, and the trusted connection is established based on the authentication result, thereby effectively distinguishing between a security terminal and an attacker by the defensive nodes, overcoming the problem of erroneously intercepting the security terminal, and then achieving the technical effect of accurately detecting the attacker for effective defense. The address of the defensive node to which the signaling request is sent the next time is sent directly to the terminal that establishes the trusted connection by the dispatching instruction, thereby avoiding exposing all nodes to the terminal, and improving the security of the defensive node devices.

Further, before the returning a dispatching instruction to the terminal, the method further includes: determining the defensive node device to which the terminal sends the signaling request the next time based on a defensive policy, wherein the defensive policy is used for dispatching between the at least two defensive node devices.

Accordingly, the above embodiments have the following advantages or beneficial effects: the defensive nodes are reasonably allocated based on the dispatching policy, thereby reasonably dispatching use of the defensive nodes based on the current defense situation and resource occupancy situation, and achieving the technical effect of improving the defense processing efficiency.

Further, the determining the defensive node device to which the terminal sends the signaling request the next time based on a defensive policy includes: acquiring a current attack situation of each defensive node device; and determining a current response performance of each defensive node device based on the attack situation, and determining the defensive node device to which the terminal sends the signaling request the next time based on a principle of balanced response performance.

Accordingly, the above embodiments have the following advantages or beneficial effects: the defensive node device to which the terminal sends the signaling request the next time is adaptively adjusted based on the attack situation of the defensive node devices, thereby achieving reasonable allocation of the defensive node devices, ensuring the effectiveness of the defense, and improving the processing efficiency.

Further, the determining the defensive node device to which the terminal sends the signaling request the next time based on a defensive policy includes: acquiring a user level of the terminal, the user level being divided based on an APP service feature of a user; and determining the defensive node device to which the terminal sends the signaling request the next time based on a corresponding relationship between the user level and a node level; where the at least two defensive node devices are divided based on the node level.

Accordingly, the above embodiments have the following advantages or beneficial effects: the defensive nodes are allocated based on the corresponding relationship between the user level and the node level, thereby reducing the scope generated by the attack, and improving the effectiveness and stability of the defense.

Further, the node level includes a high level and other levels except for the high level; and accordingly, in response to a current defensive node device that establishes the trusted connection with the terminal belonging to the high level, the method further includes: dispatching, in response to monitoring occurrence of an attacking behavior on a defensive node device of the high level, a terminal with the user level higher than a first set threshold among at least one terminal that establishes the trusted connection with the defensive node device of the high level to a backup defensive node device by returning the dispatching instruction.

Accordingly, the above embodiments have the following advantages or beneficial effects: a terminal with a level higher than the first set threshold is dispatched to the backup defensive node device, thereby ensuring the normal connection between the terminal and the defensive node devices, and avoiding affecting the normal use of the terminal.

Further, in response to the current defensive node device that establishes the trusted connection with the terminal belonging to the other levels, the method further includes: dispatching, in response to monitoring occurrence of an attacking behavior on a defensive node device of the other levels, a terminal with the user level lower than a second set threshold among at least one terminal that establishes the trusted connection with the defensive node device of the other levels to a highly defensive node device by returning the dispatching instruction; where a response performance of the highly defensive node device is higher than response performances of other defensive node devices.

Accordingly, the above embodiments have the following advantages or beneficial effects: a terminal with a level lower than the second set threshold is dispatched to a highly defensive node device, such that the highly defensive node device strictly defends against and monitor a terminal with high doubtfulness, to ensure the cybersecurity.

Further, the highly defensive node device is further configured to dispatch a terminal with a trusted connection duration reaching a preset duration threshold to a defensive node device allocated to the terminal with the trusted connection duration reaching the preset duration threshold last time by the dispatching instruction.

Accordingly, the above embodiments have the following advantages or beneficial effects: the terminal with the trusted connection duration reaching the preset duration threshold is allocated to a defensive node device that is allocated to the terminal last time, thereby achieving allocating a terminal with low doubtfulness to the original defensive node for defense and monitoring, and achieving reasonable allocation and use of the defensive nodes.

Further, the highly defensive node device is further configured to establish the trusted connection with a terminal starting the APP for a first time.

Accordingly, the above embodiments have the following advantages or beneficial effects: a terminal that starts the APP for a first time is authenticated and defended by the highly defensive node that has a response performance higher than response performances of other highly defensive nodes, such that the terminal security is more strictly validated, to ensure the terminal security.

Further, the dispatching instruction includes an address of the defensive node device to which the terminal sends the signaling request the next time, and time when the terminal sends the signaling request the next time; where, before the time comes, the terminal establishes the trusted connection with the current defensive node device.

Accordingly, the above embodiments have the following advantages or beneficial effects: the address of the defensive node device and the time of sending the signaling request are sent to the terminal, thereby achieving reasonable batch setting and dispatching of the defensive nodes.

An embodiment of the present disclosure provides a method for defending against an attacking behavior, the method being applied to a terminal provided with an APP, the method including: sending a signaling request to defensive node devices, a number of the defensive node devices being at least two, the signaling request being used for requesting for establishing a trusted connection with the defensive node devices, and the signaling request at least including information of the terminal and the APP; establishing, in response to the defensive node devices successfully authenticating the terminal based on the information of the terminal and the APP, the trusted connection with the defensive node devices, and forwarding APP traffic of the terminal to a source station of the APP by the defensive node devices; and determining, based on a dispatching instruction returned by the defensive node devices, a defensive node device to which the signaling request is sent a next time.

Accordingly, the above embodiments have the following advantages or beneficial effects: the signaling request is sent to the defensive nodes, the terminal and the APP are authenticated by the defensive nodes, and the trusted connection is established based on the authentication result, thereby effectively distinguishing between a security terminal and an attacker by the defensive nodes, overcoming the problem of erroneously intercepting the security terminal, and then achieving the technical effect of accurately detecting the attacker for effective defense.

Further, before the sending a signaling request to defensive node devices, the method further includes: acquiring, in response to starting the APP, an address of the defensive node devices by a domain name resolution server; where the domain name resolution server is configured to allocate a defensive node device to the terminal through domain name resolution, the defensive node device is a highly defensive node device, and a response performance of the highly defensive node device is higher than response performances of other defensive node devices.

Accordingly, the above embodiments have the following advantages or beneficial effects: the address of the defensive node devices is acquired by the domain name resolution server, and the highly defensive node device is allocated to the terminal, such that the security of the highly defensive node device is strictly defended, to ensure the security of the terminal connection.

Further, the dispatching instruction comprises an address of the defensive node device to which the terminal sends the signaling request the next time, and time when the terminal sends the signaling request the next time; where, before the time comes, the terminal establishes the trusted connection with a current defensive node device.

Accordingly, the above embodiments have the following advantages or beneficial effects: the address of the defensive node devices is acquired by the domain name resolution server, and the highly defensive node device is allocated to the terminal, such that the security of the highly defensive node device is strictly defended, to ensure the security of the terminal connection.

An embodiment of the present disclosure provides an apparatus for defending against an attacking behavior, the apparatus being provided in defensive node devices, and a number of the defensive node devices being at least two, the apparatus including: a receiving module configured to receive a signaling request sent by a terminal provided with an APP, the signaling request being used for requesting for establishing a trusted connection with the defensive node devices, and the signaling request at least including information of the terminal and the APP; n authenticating module configured to authenticate the terminal based on the information of the terminal and the APP, establish, in response to the authenticating the terminal being successful, the trusted connection with the terminal, and forward APP traffic from the terminal to a source station of the APP; and a dispatching instruction returning module configured to return a dispatching instruction to the terminal, the dispatching instruction being used for instructing a defensive node device to which the terminal sends the signaling request a next time.

An embodiment of the present disclosure further provides an apparatus for defending against an attacking behavior, the apparatus being provided in a terminal provided with an APP, the apparatus including: a signaling request sending module configured to send a signaling request to defensive node devices, a number of the defensive node devices being at least two, the signaling request being used for requesting for establishing a trusted connection with the defensive node devices, and the signaling request at least including information of the terminal and the APP; a trusted connection establishing module configured to establish, in response to the defensive node devices successfully authenticating the terminal based on the information of the terminal and the APP, the trusted connection with the defensive node devices, and forward APP traffic of the terminal to a source station of the APP by the defensive node devices; and a dispatching instruction responding module configured to determine, based on a dispatching instruction returned by the defensive node devices, a defensive node device to which the signaling request is sent a next time.

An embodiment of the present disclosure further provides an electronic device, including: at least one processor; and a memory in communication connection with the at least one processor; where the memory stores instructions is executable by the at least one processor, and the instructions when executed by the at least one processor, cause the at least one processor to execute the method, for defending against an attacking behavior, applied to defensive node devices, according to any embodiment of the present disclosure.

An embodiment of the present disclosure further provides a terminal, including: at least one processor; and a memory in communication connection with the at least one processor; where the memory stores instructions is executable by the at least one processor, and the instructions, when executed by the at least one processor, cause the at least one processor execute the method, for defending against an attacking behavior, applied to a terminal provided with an APP, according to any embodiment of the present disclosure.

An embodiment of the present disclosure further provides a non-transitory computer readable storage medium storing a computer instruction, where the computer instruction is used for causing a computer to execute the method, for defending against an attacking behavior, applied to defensive node devices, according to any embodiment of the present disclosure.

An embodiment of the present disclosure further provides a non-transitory computer readable storage medium storing a computer instruction, wherein the computer instruction is used for causing a computer to execute the method, for defending against an attacking behavior, applied to a terminal provided with an APP, according to any embodiment of the present disclosure.

Other effects of the above alternative implementations will be described below with reference to the specific embodiments.

### BRIEF DESCRIPTION OF THE DRAWINGS

The accompanying drawings are used for better understanding of the present solution, and do not constitute a limitation to the present disclosure.

FIG. 1 is a schematic flowchart of a method for defending against an attacking behavior provided by an embodiment of the present disclosure;

FIG. 2 is a schematic flowchart of another method for defending against an attacking behavior provided by an embodiment of the present disclosure;

FIG. 3 is a schematic flowchart of still another method for defending against an attacking behavior provided by an embodiment of the present disclosure;

FIG. 4 is a schematic structural diagram of an apparatus for defending against an attacking behavior provided by an embodiment of the present disclosure;

FIG. 5 is a schematic structural diagram of another apparatus for defending against an attacking behavior provided by an embodiment of the present disclosure;

FIG. 6 is a block diagram of an electronic device for implementing the method for defending against an attacking behavior provided by an embodiment of the present disclosure; and

FIG. 7 is a block diagram of a terminal for implementing a method for defending against an attacking behavior provided by an embodiment of the present disclosure.

### DETAILED DESCRIPTION OF EMBODIMENTS

Example embodiments of the present disclosure are described below with reference to the accompanying drawings, which include various details of the embodiments of the present disclosure to facilitate understanding, and should be considered merely as examples. Therefore, those of ordinary skills in the art should realize that various alterations and modifications can be made to the embodiments described herein without departing from the scope and spirit of the present disclosure. Similarly, for clearness and conciseness, descriptions of well-known functions and structures are omitted in the following description.

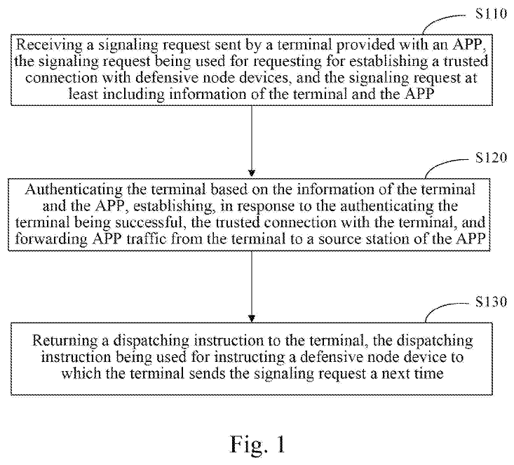

FIG. 1 is a schematic flowchart of a method for defending against an attacking behavior provided by an embodiment of the present disclosure. The present embodiment may be adapted to a case of defending against a cyberattack. Typically, the present embodiment may be adapted to a case of, during network access of an APP installed in a terminal, defending against a cyber-attacker when the cyber-attacker performs a cyberattack by stimulating the APP. The method for defending against an attacking behavior disclosed in the present embodiment is applied to defensive node devices, the number of the defensive node devices is at least two, and the method may be executed by an apparatus for defending against an attacking behavior. The apparatus may be implemented by software and/or hardware, and is provided in the defensive node devices. Referring to FIG. 1, the method for defending against an attacking behavior provided in the present embodiment includes the following steps.

S110: receiving a signaling request sent by a terminal provided with an APP, the signaling request being used for requesting for establishing a trusted connection with defensive node devices, and the signaling request at least including information of the terminal and the APP.

The signaling request may include encrypted fields, terminal model, terminal serial number, and the like required for authenticating the defensive node devices, as well as APP version, installation package path, installation package size, etc. The information contained in the signaling request may indicate identify of the terminal and the APP, thereby distinguishing whether the terminal is a security terminal or an attacker.

As an example, when the APP installed in the terminal is started, a specific software development kit (SDK) preloaded in the terminal may determine an address of the defensive node devices through a domain name resolution service, and the SDK sends the signaling request to the defensive node devices based on the address of the defensive node devices, to request for establishing a connection with the defensive node devices. The SDK may be a SDK used for implementing processes of some embodiments of the present disclosure, and may be preloaded in the terminal without the need for making any change of the APP, thereby providing wider applicability and great convenience.

In order to prevent the terminal from directly accessing to the APP server, and avoid causing an attacker to directly access to the server and perform a cyberattack on the server, some embodiments of the present disclosure receive the signaling request sent by the terminal via the defensive node devices, thereby isolating the terminal from the server, and effectively defending against the cyberattack of the attacker. The signaling request for requesting for establishing the trusted connection with the defensive node devices is sent, such that the defensive node devices may be connected with a security terminal, to achieving forwarding traffic.

S120: authenticating the terminal based on the information of the terminal and the APP, establishing, in response to the authenticating the terminal being successful, the trusted connection with the terminal, and forwarding APP traffic from the terminal to a source station of the APP.

As an example, in order to effectively distinguish between the security terminal and the attacker, the defensive node devices need to authenticate the identity of the terminal. The defensive node devices authenticate the terminal based on the terminal information and the APP information in the signaling request. The authentication approach may be that terminal information and APP information of the security terminal are pre-stored in the defensive node devices, and the received terminal information and APP information is matched with the terminal information and the APP information of the security terminal. If the received terminal information and APP information successfully match the terminal information and the APP information of the security terminal, then the terminal is the security terminal. Then, in response to the signaling request, the trusted connection with the terminal is established, and the APP traffic from the terminal is forwarded to the source station of the APP. If the received terminal information and APP information fail to match the terminal information and the APP information of the security terminal, then the terminal may be the attacker, and then the trusted connection is refused to prevent the terminal from performing a cyberattack.

The terminal is authenticated by the defensive node devices, thereby accurately distinguishing between the security terminal and the attacker. A new connection with the security terminal is established, to ensure normal access of the security terminal to the server. The trusted connection with the attacker is refused, to achieve effective defense against attacks.

S130: returning a dispatching instruction to the terminal, the dispatching instruction being used for instructing a defensive node device to which the terminal sends the signaling request a next time.

Specifically, if the terminal always keeps establishing the trusted connection with a defensive node device, then when the defensive node device has too heavy load or is attacked by a cyberattacker, normal traffic forwarding and attack defense cannot be guaranteed. Therefore, the defensive node devices in some embodiments of the present disclosure return the dispatching instruction to the terminal, thereby allocating and dispatching at least two defensive node devices by the dispatching instruction, realizing reasonable utilization of the defensive node device resources, and ensuring stable processing of the traffic forwarding and the attack defense.

Alternatively, the dispatching instruction includes an address of the defensive node device to which the terminal sends the signaling request the next time, and time when the terminal sends the signaling request the next time; where, before the time comes, the terminal establishes the trusted connection with a current defensive node device.

Specifically, in order to ensure reasonable allocation of the defensive node devices, the dispatching instruction of some embodiments of the present disclosure includes the address of the defensive node device to which the signaling request is sent the next time, and the time when the terminal sends the signaling request the next time, such that when the defensive node device of a current trusted connection has an address change, fails, or is cyberattacked, the terminal is dispatched promptly to be connected with other defensive node devices, to ensure the smooth defense and the stability of terminal services. In addition, the dispatching instruction sends the address of the defensive node device to which the signaling request is sent the next time directly to the terminal that establishes the trusted connection, thereby avoiding exposing all nodes to any terminal, and improving the security of the defensive node devices and the whole defensive system.

The technical solutions of some embodiments of the present disclosure authenticate the terminal and the APP by defensive nodes, and establish the trusted connection based on the authentication result, thereby effectively distinguishing between the security terminal and the attacker by the defensive nodes, overcoming the problem of erroneously intercepting the security terminal, and then achieving the technical effect of accurately detecting the attacker for effective defense.

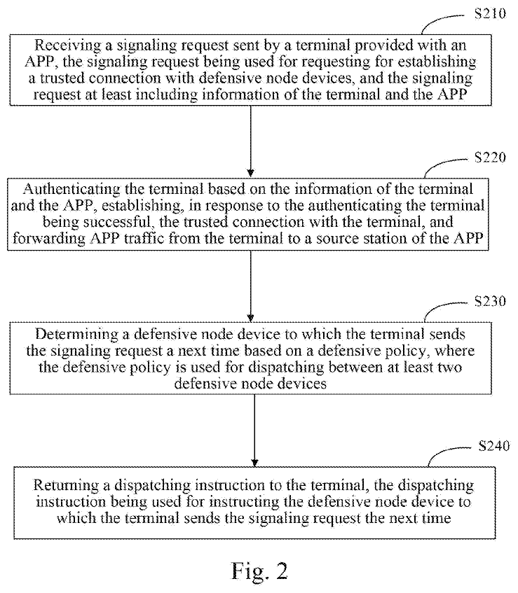

FIG. 2 is a schematic flowchart of another method for defending against an attacking behavior provided by an embodiment of the present disclosure. The present embodiment is optimized on the basis of the above embodiments. Referring to FIG. 2, the method for defending against an attacking behavior provided by the present embodiment includes the following steps.

S210: receiving a signaling request sent by a terminal provided with an APP, the signaling request being used for requesting for establishing a trusted connection with defensive node devices, and the signaling request at least including information of the terminal and the APP.

S220: authenticating the terminal based on the information of the terminal and the APP, establishing, in response to the authenticating the terminal being successful, the trusted connection with the terminal, and forwarding APP traffic from the terminal to a source station of the APP.

S230: determining a defensive node device to which the terminal sends the signaling request a next time based on a defensive policy, where the defensive policy is used for dispatching between at least two defensive node devices.

Alternatively, the determining the defensive node device to which the terminal sends the signaling request a next time based on a defensive policy includes: acquiring a current attack situation of each defensive node device; and determining a current response performance of each defensive node device based on the attack situation, and determining the defensive node device to which the terminal sends the signaling request the next time based on a principle of balanced response performance.

As an example, when the defensive node device is attacked by a cyber-attacker, there may a situation that the response performance on the signaling request of the terminal is decreased. However, in this case, the response performance of a defensive node device that is not cyberattacked is normal. The terminal may be commanded to establish the trusted connection with the defensive node device with a normal response performance. Therefore, in some embodiments of the present disclosure, the current attack situation of each defensive node device is acquired, thereby analyzing the response performance of each defensive node device based on the attack situation, and determining the defensive node device to which the terminal sends the signaling request the next time based on the principle of balanced response performance. For example, if a current defensive node device that establishes the trusted connection with the terminal is cyberattacked with weakened response performance, then the terminal is commanded to send the signaling request to the defensive node device that is not cyberattacked the next time, thereby ensuring normal response to the signaling request of the terminal.

In another alternative embodiment, the determining the defensive node device to which the terminal sends the signaling request a next time based on a defensive policy includes: acquiring a user level of the terminal, the user level being divided based on an APP service feature of a user; and determining the defensive node device to which the terminal sends the signaling request the next time based on a corresponding relationship between the user level and a node level; where the at least two defensive node devices are divided based on the node level.

As an example, in order to reduce the impacts caused by a cyberattack, in some embodiments of the present disclosure, the defensive node device to which the terminal sends the signaling request the next time is determined based on the corresponding relationship between the user level and the node level. For example, for an APP, if the user registered an account of the APP earlier or transferred a large amount of money to the account, then the user is determined as a high-level user, and terminals corresponding to the APP of such users may be determined as security terminals. At the same time, the defensive node devices are divided into different levels, such as a high-level defensive node device, a medium-level defensive node device, and a low-level defensive node device. A terminal corresponding to a low-level user may be allocated to a low-level defensive node device, a terminal corresponding to a medium-level user may be allocated to medium-level defensive node device, and a terminal corresponding to a high-level user may be allocated to a high-level defensive node device. The defensive node devices are allocated based on the corresponding relationship between the user level and the node level, thereby achieving centralized management and defense of terminals corresponding to users of the same level, avoiding affecting terminals corresponding to users of other levels during a cyberattack, and reducing the impacts caused by the attack.

S240: returning a dispatching instruction to the terminal, the dispatching instruction being used for instructing the defensive node device to which the terminal sends the signaling request the next time.

The technical solutions of some embodiments of the present disclosure determine the defensive node device to which the terminal sends the signaling request the next time based on the defensive policy, and dispatch between at least two defensive node devices based on the defensive policy, thereby achieving reasonable allocation of each defensive node device, and improving the defense security and the service stability.

Alternatively, the defensive node device to which the terminal sends the signaling request the next time may be further determined based on a load balancing policy, and dispatching may be performed between at least two defensive node devices based on the load balancing policy. For example, when a load of the defensive node device that establishes the trusted connection with the terminal is heavy, the terminal is commanded to send the signaling request to other defensive node devices with a small load the next time, to request for establishing the trusted connection with the other defensive node devices, thereby achieving reasonable allocation and application of the defensive node devices.

Alternatively, the node level includes a high level and other levels except for the high level; and accordingly, in response to a current defensive node device that establishes the trusted connection with the terminal belonging to the high level, the method further includes: dispatching, in response to monitoring occurrence of an attacking behavior on a defensive node device of the high level, a terminal with the user level higher than a first set threshold among at least one terminal that establishes the trusted connection with the defensive node device of the high level to a backup defensive node device by returning the dispatching instruction.

In response to the current defensive node device that establishes the trusted connection with the terminal belonging to the other levels, the method further includes: dispatching, in response to monitoring occurrence of an attacking behavior on a defensive node device of the other levels, a terminal with the user level lower than a second set threshold among at least one terminal that establishes the trusted connection with the defensive node device of the other levels to a highly defensive node device by returning the dispatching instruction; where a response performance of the highly defensive node device is higher than response performances of the other defensive node devices. The highly defensive node device is further configured to dispatch a terminal with a trusted connection duration reaching a preset duration threshold to a defensive node device allocated to the terminal with the trusted connection duration reaching the preset duration threshold last time by the dispatching instruction.

Specifically, in response to the defensive node device being attacked, the terminal with the user level higher than the first set threshold may be dispatched to the backup defensive node device, such that the backup defensive node device performs attack defense on terminals corresponding to users of higher levels, to ensure normal network access of the users, and meet the service needs of these users. For the terminal with the user level lower than the second set threshold, because the terminal is highly doubtful to be an attacker, the terminal may be dispatched to a highly defensive node device that has a response performance higher than response performances of other defensive node devices, such that the highly defensive node device strictly defends and monitors the terminal, to avoid occurrence of the attacking behavior. If a duration of the trusted connection between the highly defensive node and the terminal with the user level lower than the second set threshold reaches the preset duration threshold, then the terminal is the security terminal, and in this case, the terminal is dispatched to the defensive node device monitoring the terminal last time, in order to save the resources of the highly defensive node device, and reasonably dispatch and utilize the resources of each defensive node device.

Alternatively, the highly defensive node device is further configured to establish the trusted connection with the terminal starting the APP for a first time. Specifically, it is impossible to know whether the terminal corresponding to the APP is the security terminal when the APP is started for the first time. Therefore, to prevent the terminal from being the attacker and generating the attacking behavior, the highly defensive node device monitors and defends against the terminal, to increase the defense strength, and ensure the cybersecurity.

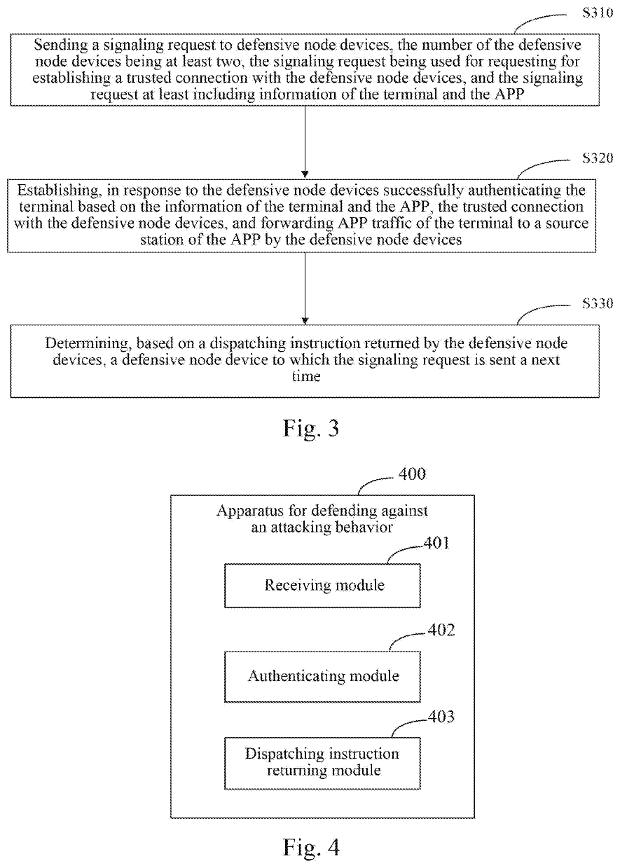

FIG. 3 is a schematic flowchart of still another method for defending against an attacking behavior provided by an embodiment of the present disclosure. The present embodiment may be adapted to a case of defending against a cyberattack. Typically, the present embodiment may be adapted to a case of, during network access of an APP installed in a terminal, defending against a cyber-attacker when the cyber-attacker performs a cyberattack by stimulating the APP. The method for defending against an attacking behavior disclosed in the present embodiment is applied to the terminal provided with the APP, and may be executed by an apparatus for defending against an attacking behavior. The apparatus may be implemented by software and/or hardware, and may be provided in the terminal. Referring to FIG. 3, the method for defending against an attacking behavior provided by the present embodiment includes the following steps.

S310: sending a signaling request to defensive node devices, the number of the defensive node devices being at least two, the signaling request being used for requesting for establishing a trusted connection with the defensive node devices, and the signaling request at least including information of the terminal and the APP.

The signaling request may include encrypted fields, terminal model, terminal serial number, and the like required for authenticating the defensive node devices, as well as APP version, installation package path, installation package size, etc. The information contained in the signaling request may indicate identify of the terminal and the APP, such that the defensive node devices distinguish whether the terminal is a security terminal or an attacker, thereby achieving defending against the attacking behavior.

Alternatively, before the sending a signaling request to defensive node devices, the method further includes: acquiring, in response to starting the APP, an address of the defensive node devices by a domain name resolution server; where the domain name resolution server is configured to allocate a defensive node device to the terminal through domain name resolution, the defensive node device is a highly defensive node device, and a response performance of the highly defensive node device is higher than response performances of other defensive node devices.

As an example, when the APP installed in the terminal is started, a specific software development kit (SDK) preloaded in the terminal may determine the address of the defensive node devices through a domain name resolution service, and the SDK sends the signaling request to the defensive node devices based on the address of the defensive node devices, to request for establishing a connection with the defensive node devices.

It is impossible to know whether the terminal corresponding to the APP is the security terminal when the APP is started for a first time. Therefore, to prevent the terminal from being the attacker and generating the attacking behavior, the domain name resolution server allocates the highly defensive node device with the response performance higher than the response performances of the other defensive node devices to the terminal for a first time, the highly defensive node device monitors and defends against the terminal, to increase the defense strength, and ensure the cybersecurity.

S320: establishing, in response to the defensive node devices successfully authenticating the terminal based on the information of the terminal and the APP, the trusted connection with the defensive node devices, and forwarding APP traffic of the terminal to a source station of the APP by the defensive node devices.

In order to effectively distinguish between the security terminal and the attacker, the defensive node devices need to authenticate the identity of the terminal. The defensive node devices authenticate the terminal based on the terminal information and the APP information in the signaling request, and in response to the authenticating the terminal being successful, the terminal establishes the trusted connection with the defensive node devices, thereby forwarding APP traffic to a source station of the APP, i.e., an APP server, by the defensive node devices.

S330: determining, based on a dispatching instruction returned by the defensive node devices, a defensive node device to which the signaling request is sent a next time.

The dispatching instruction includes an address of the defensive node device to which the terminal sends the signaling request the next time, and time when the terminal sends the signaling request the next time; where, before the time comes, the terminal establishes the trusted connection with a current defensive node device.

Specifically, in order to ensure reasonable allocation of the defensive node devices, the dispatching instruction of some embodiments of the present disclosure includes the address of the defensive node device to which the signaling request is sent the next time, and the time when the terminal sends the signaling request the next time, such that when the defensive node device of a current trusted connection has an address change, fails, or is cyberattacked, the defensive node device connected with the terminal is dispatched promptly, to ensure the stability of the attack defense. The terminal determines, based on the dispatching instruction returned by the defensive node devices, the address of the defensive node device to which the signaling request is sent the next time, and the time when the terminal sends the signaling request the next time, such that before the time when the signaling request is sent the next time comes, the signaling request is sent to the defensive node device based on the address of the defensive node device to which the signaling request is sent the next time in the dispatching instruction, to request the defensive device node for establishing the trusted connection with the terminal, thereby achieving defending against the attacking behavior.

The technical solutions of some embodiments of the present disclosure send the signaling request to defensive nodes to authenticate the terminal and the APP by the defensive nodes, and establish the trusted connection based on the authentication result, thereby effectively distinguishing between the security terminal and the attacker by the defensive nodes, overcoming the problem of erroneously intercepting the security terminal, and then achieving the technical effect of accurately detecting the attacker for effective defense.

FIG. 4 is a schematic structural diagram of an apparatus for defending against an attacking behavior provided by an embodiment of the present disclosure. Referring to FIG. 4, an embodiment of the present disclosure discloses an apparatus 400 for defending against an attacking behavior. The apparatus is provided in defensive node devices, and the number of the defensive node devices is at least two. The apparatus 400 includes: a receiving module 401, an authenticating module 402, and a dispatching instruction returning module 403.

The receiving module 401 is configured to receive a signaling request sent by a terminal provided with an APP, where the signaling request is used for requesting for establishing a trusted connection with the defensive node devices, and the signaling request at least includes information of the terminal and the APP.

The authenticating module 402 is configured to authenticate the terminal based on the information of the terminal and the APP, establish, in response to the authenticating the terminal being successful, the trusted connection with the terminal, and forward APP traffic from the terminal to a source station of the APP.

The dispatching instruction returning module 403 is configured to return a dispatching instruction to the terminal, where the dispatching instruction is used for instructing a defensive node device to which the terminal sends the signaling request a next time.

The technical solutions of some embodiments of the present disclosure authenticate the terminal and the APP by defensive nodes, and establish the trusted connection based on the authentication result, thereby effectively distinguishing between the security terminal and the attacker by the defensive nodes, overcoming the problem of erroneously intercepting the security terminal, and then achieving the technical effect of accurately detecting the attacker for effective defense.

Further, the apparatus further includes: a sending determining module configured to determine the defensive node device to which the terminal sends the signaling request the next time based on a defensive policy, where the defensive policy is used for dispatching between the at least two defensive node devices.

Further, the sending determining module includes: an attack situation acquiring unit configured to acquire a current attack situation of each defensive node device; and a balanced allocation unit configured to determine a current response performance of each defensive node device based on the attack situation, and determine the defensive node device to which the terminal sends the signaling request the next time based on a principle of balanced response performance.

Further, the sending determining module includes: a dividing unit configured to acquire a user level of the terminal, the user level being divided based on an APP service feature of a user; and a corresponding relationship allocating unit configured to determine the defensive node device to which the terminal sends the signaling request the next time based on a corresponding relationship between the user level and a node level; where the at least two defensive node devices are divided based on the node level.

Further, the node level includes a high level and other levels except for the high level; and accordingly, in response to a current defensive node device that establishes the trusted connection with the terminal belonging to the high level, the apparatus further includes: a first dispatching module configured to dispatch, in response to monitoring occurrence of an attacking behavior on a defensive node device of the high level, a terminal with the user level higher than a first set threshold among at least one terminal that establishes the trusted connection with the defensive node device of the high level to a backup defensive node device by returning the dispatching instruction.

Further, in response to the current defensive node device that establishes the trusted connection with the terminal belonging to the other levels, the apparatus further includes: a second dispatching module configured to dispatch, in response to monitoring occurrence of an attacking behavior on a defensive node device of the other levels, a terminal with the user level lower than a second set threshold among at least one terminal that establishes the trusted connection with the defensive node device of the other levels to a highly defensive node device by returning the dispatching instruction; where a response performance of the highly defensive node device is higher than response performances of other defensive node devices.

Further, the highly defensive node device is further configured to dispatch a terminal with a trusted connection duration reaching a preset duration threshold to a defensive node device allocated to the terminal with the trusted connection duration reaching the preset duration threshold last time by the dispatching instruction.

Further, the highly defensive node device is further configured to establish the trusted connection with the terminal starting the APP for a first time.

Further, the dispatching instruction includes an address of the defensive node device to which the terminal sends the signaling request the next time, and time when the terminal sends the signaling request the next time.

Before the time comes, the terminal establishes the trusted connection with a current defensive node device.

The apparatus for defending against an attacking behavior provided by some embodiments of the present disclosure may execute the method for defending against an attacking behavior applied to defensive node devices provided by any embodiment of the present disclosure, and has corresponding function modules for executing the method and beneficial effects.

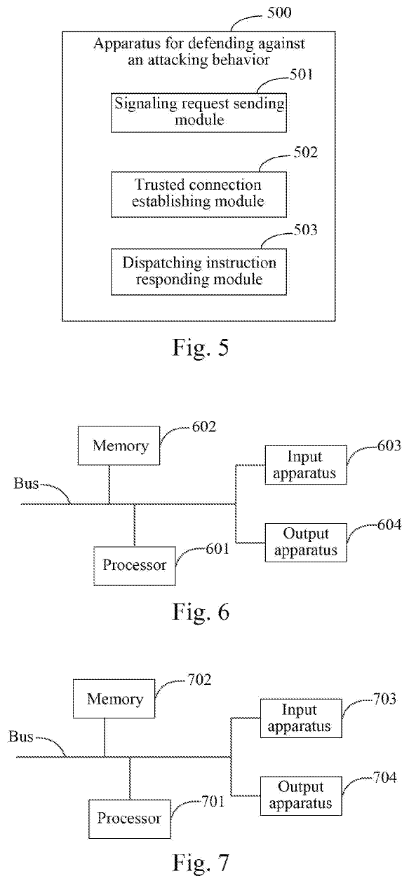

FIG. 5 is a schematic structural diagram of another apparatus for defending against an attacking behavior provided by an embodiment of the present disclosure. Referring to FIG. 5, an embodiment of the present disclosure discloses an apparatus 500 for defending against an attacking behavior. The apparatus is provided in a terminal provided with an APP. The apparatus 500 includes: a signaling request sending module 501, a trusted connection establishing module 502, and a dispatching instruction responding module 503.

The signaling request sending module 501 is configured to send a signaling request to defensive node devices, where the number of the defensive node devices is at least two, the signaling request is used for requesting for establishing a trusted connection with the defensive node devices, and the signaling request at least includes information of the terminal and the APP.

The trusted connection establishing module 502 is configured to establish, in response to the defensive node devices successfully authenticating the terminal based on the information of the terminal and the APP, the trusted connection with the defensive node devices, and forwarding APP traffic of the terminal to a source station of the APP by the defensive node devices.

The dispatching instruction responding module 503 is configured to determine, based on a dispatching instruction returned by the defensive node devices, a defensive node device to which the signaling request is sent a next time.

The technical solutions of some embodiments of the present disclosure send the signaling request to defensive nodes to authenticate the terminal and the APP by the defensive nodes, and establish the trusted connection based on the authentication result, thereby effectively distinguishing between the security terminal and the attacker by the defensive nodes, overcoming the problem of erroneously intercepting the security terminal, and then achieving the technical effect of accurately detecting the attacker for effective defense.

Further, the apparatus further includes: a responding module configured to acquire, in response to starting the APP, an address of the defensive node devices by a domain name resolution server.

The domain name resolution server is configured to allocate a defensive node device to the terminal through domain name resolution, the defensive node device is a highly defensive node device, and a response performance of the highly defensive node device is higher than response performances of other defensive node devices.

Further, the dispatching instruction includes an address of the defensive node device to which the terminal sends the signaling request the next time, and time when the terminal sends the signaling request the next time.

Before the time comes, the terminal establishes the trusted connection with a current defensive node device.

The apparatus for defending against an attacking behavior provided by some embodiments of the present disclosure may execute the method for defending against an attacking behavior applied to a terminal provided by any embodiment of the present disclosure, and has corresponding function modules for executing the method and beneficial effects.

According to some embodiments of the present disclosure, the present disclosure further provides an electronic device and a readable storage medium.

As shown in FIG. 6, a block diagram of an electronic device for implementing the method for defending against an attacking behavior provided by an embodiment of the present disclosure is shown. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital assistant, a cell phone, a smart phone, a wearable device, and other similar computing devices. The components shown herein, the connections and relationships thereof, and the functions thereof are meant to be examples only, and are not intended to limit implementations of the present disclosure described and/or claimed herein.

As shown in FIG. 6, the electronic device includes: one or more processors 601, a memory 602, and interfaces for connecting various components, including a high-speed interface and a low-speed interface. The various components are interconnected using different buses, and may be mounted on a common motherboard or in other manners as required. The processor may process instructions for execution within the electronic device, including instructions stored in the memory or on the memory to display graphical information for a GUI on an external input/output apparatus (e.g., a display device coupled to an interface). In other embodiments, a plurality of processors and/or a plurality of buses may be used, if necessary, along with a plurality of memories. Also, a plurality of electronic devices may be connected, with each device providing portions of the necessary operations (e.g., as a server array, a group of blade servers, or a multi-processor system). FIG. 6 takes a processor 601 as an example.

The memory 602 is a non-transitory computer readable storage medium provided by some embodiments of the present disclosure. The memory stores instructions executable by at least one processor, such that the at least one processor executes the method for defending against an attacking behavior applied to defensive node devices provided by the present disclosure. The non-transitory computer readable storage medium of the present disclosure stores computer instructions. The computer instructions are used for causing a computer to execute the method for defending against an attacking behavior applied to defensive node devices provided by the present disclosure.

As a non-transitory computer readable storage medium, the memory 602 may be configured to store non-transitory software programs, non-transitory computer executable programs and modules, such as the program instructions/modules (e.g., the receiving module 401, the authenticating module 402, and the dispatching instruction returning module 403 shown in FIG. 4) corresponding to the method for defending against an attacking behavior applied to defensive node devices in some embodiments of the present disclosure. The processor 601 runs non-transitory software programs, instructions and modules stored in the memory 602, to execute various function applications of a server and data processing, i.e., implementing the method for defending against an attacking behavior applied to defensive node devices in the above embodiments of the method.

The memory 602 may include a program storage area and a data storage area. The program storage area may store an operating system and an application required for at least one function. The data storage area may store data and the like created according to the usage of an electronic device. In addition, the memory 602 may include a high-speed random access memory, and may also include a non-transitory memory, e.g., at least one disk storage device, a flash memory device or other non-transitory solid-state storage devices. In some embodiments, the memory X20 may further include memories remotely arranged relative to the processor 601, where the remote memories may be connected to the terminal device by a network. An example of the above network includes but not limited to, the Internet, an enterprise intranet, a local area network, a mobile communications network, and a combination thereof.

The electronic device of the method for defending against an attacking behavior may further include: an input apparatus 603 and an output apparatus 604. The processor 601, the memory 602, the input apparatus 603, and the output apparatus 604 may be connected through a bus or in other manners. Bus connection is taken as an example in FIG. 6.

The input apparatus 603 may receive inputted number or character information, and generate key signal input related to user settings and function control of the electronic device for defending against an attacking behavior, e.g., an input apparatus such as a touch screen, a keypad, a mouse, a trackpad, a touchpad, an indicating arm, one or more mouse buttons, a trackball, and a joystick. The output apparatus 604 may include a display device, an auxiliary lighting apparatus (e.g., an LED), a haptic feedback apparatus (e.g., a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuit system, an integrated circuit system, an ASIC (application specific integrated circuit), computer hardware, firmware, software, and/or a combination thereof. The various embodiments may include: implementation in one or more computer programs that are executable and/or interpretable on a programmable system including at least one programmable processor, which may be special purpose or general purpose programmable processor, may receive data and instructions from, and to transmit data and instructions to, a storage system, at least one input apparatus, and at least one output apparatus.

These computer programs (also known as programs, software, software applications, or code) include machine instructions for a programmable processor, and may be implemented in a high-level procedural and/or object-oriented programming language, and/or in assembly/machine language. As used herein, the terms “machine readable medium” and “computer readable medium” refer to any computer program product, device, and/or apparatus (e.g., a magnetic disk, an optical disk, a memory, or a programmable logic device (PLD)) used to provide machine instructions and/or data to a programmable processor, and include a machine readable medium receiving a machine instruction as a machine readable signal. The term “machine readable signal” refers to any signal used to provide machine instructions and/or data to a programmable processor.

To provide interaction with a user, the systems and technologies described herein can be implemented on a computer that has: a display apparatus (e.g., a CRT (cathode ray tube) or a LCD (liquid crystal display) monitor) for displaying information to the user); and a keyboard and a pointing apparatus (e.g., a mouse or a trackball) through which the user can provide input to the computer. Other kinds of apparatus may also be used to provide interaction with the user. For example, the feedback provided to the user may be any form of sensory feedback (e.g., visual feedback, auditory feedback, or haptic feedback); and may receive input from the user in any form (including acoustic input, voice input, or tactile input).

The systems and technologies described herein may be implemented in a computing system that includes a back-end component (for example, as a data server), or a computing system that includes a middleware component (for example, an application server), or a computing system that includes a front-end component (for example, a user computer with a graphical user interface or a web browser through which the user can interact with an implementation of the systems and technologies described herein), or any combination of such back-end component, middleware component, or front-end component. The components of the system can be interconnected by any form or medium of digital data communication (e.g., a communication network). Examples of communication networks include a local area network (LAN), a wide area network (WAN), and the Internet.

The computer system may include clients and servers. A client and server are generally remote from each other and typically interact through a communication network. The relationship of client and server arises by virtue of computer programs running on corresponding computers and having a client-server relationship to each other.

According to some embodiments of the present disclosure, the present disclosure further provides a terminal and a readable storage medium.

As shown in FIG. 7, a block diagram of a terminal for implementing the method for defending against an attacking behavior provided by an embodiment of the present disclosure is shown. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital assistant, a cell phone, a smart phone, a wearable device, and other similar computing devices. The components shown herein, the connections and relationships thereof, and the functions thereof are meant to be examples only, and are not intended to limit implementations of the present disclosure described and/or claimed herein.

As shown in FIG. 7, the electronic device includes: one or more processors 701, a memory 702, and interfaces for connecting various components, including a high-speed interface and a low-speed interface. The various components are interconnected using different buses, and may be mounted on a common motherboard or in other manners as required. The processor can process instructions for execution within the electronic device, including instructions stored in the memory or on the memory to display graphical information for a GUI on an external input/output apparatus (e.g., a display device coupled to an interface). In other embodiments, a plurality of processors and/or a plurality of buses may be used, if necessary, along with a plurality of memories. Also, a plurality of electronic devices may be connected, with each device providing portions of the necessary operations (e.g., as a server array, a group of blade servers, or a multi-processor system). FIG. 7 takes a processor 701 as an example.

The memory 702 is a non-transitory computer readable storage medium provided by the present disclosure. The memory stores instructions executable by at least one processor, such that the at least one processor executes the method for defending against an attacking behavior applied to a terminal provided with an APP provided by the present disclosure. The non-transitory computer readable storage medium of the present disclosure stores computer instructions. The computer instructions are used for causing a computer to execute the method for defending against an attacking behavior applied to a terminal provided with an APP provided by the present disclosure.

As a non-transitory computer readable storage medium, the memory 702 may be configured to store non-transitory software programs, non-transitory computer executable programs and modules, such as the program instructions/modules (e.g., the signaling request sending module 501, the trusted connection establishing module 502, and the dispatching instruction responding module 503 shown in FIG. 5) corresponding to the method for defending against an attacking behavior applied to a terminal provided with an APP in some embodiments of the present disclosure. The processor 701 runs non-transitory software programs, instructions and modules stored in the memory 702, to execute various function applications of a server and data processing, i.e., implementing the method for defending against an attacking behavior applied to a terminal provided with an APP in the above embodiments of the method.

The memory 702 may include a program storage area and a data storage area, where the program storage area may store an operating system and applications required by at least one function; and the data storage area may store, e.g., data created based on use of the electronic device for defending against an attacking behavior. In addition, the memory 702 may include a high-speed random access memory, and may further include a non-transitory memory, such as at least one magnetic disk storage component, a flash memory component, or other non-transitory solid-state storage components. In some embodiments, the memory 702 may alternatively include memories disposed remotely relative to the processor 701, and these remote memories may be connected to the electronic device for defending against an attacking behavior via a network. Examples of the above network include, but are not limited to, the Internet, an intranet, a local area network, a mobile communication network, and a combination thereof.

The electronic device of the method for defending against an attacking behavior may further include: an input apparatus 703 and an output apparatus 704. The processor 701, the memory 702, the input apparatus 703, and the output apparatus 704 may be connected through a bus or in other manners. Bus connection is taken as an example in FIG. 7.

The input apparatus 703 may receive inputted number or character information, and generate key signal input related to user settings and function control of the electronic device for defending against an attacking behavior, e.g., an input apparatus such as a touch screen, a keypad, a mouse, a trackpad, a touchpad, an indicating arm, one or more mouse buttons, a trackball, and a joystick. The output apparatus 704 may include a display device, an auxiliary lighting apparatus (e.g., an LED), a haptic feedback apparatus (e.g., a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuit system, an integrated circuit system, an ASIC (application specific integrated circuit), computer hardware, firmware, software, and/or a combination thereof. The various embodiments may include: implementation in one or more computer programs that are executable and/or interpretable on a programmable system including at least one programmable processor, which may be special purpose or general purpose programmable processor, may receive data and instructions from, and to transmit data and instructions to, a storage system, at least one input apparatus, and at least one output apparatus.

These computer programs (also known as programs, software, software applications, or code) include machine instructions for a programmable processor, and may be implemented in a high-level procedural and/or object-oriented programming language, and/or in assembly/machine language. As used herein, the terms “machine readable medium” and “computer readable medium” refer to any computer program product, device, and/or apparatus (e.g., a magnetic disk, an optical disk, a memory, or a programmable logic device (PLD)) used to provide machine instructions and/or data to a programmable processor, and include a machine readable medium receiving a machine instruction as a machine readable signal. The term “machine readable signal” refers to any signal used to provide machine instructions and/or data to a programmable processor.

To provide interaction with a user, the systems and technologies described herein can be implemented on a computer that has: a display apparatus (e.g., a CRT (cathode ray tube) or a LCD (liquid crystal display) monitor) for displaying information to the user); and a keyboard and a pointing apparatus (e.g., a mouse or a trackball) through which the user can provide input to the computer. Other kinds of apparatus may also be used to provide interaction with the user. For example, the feedback provided to the user may be any form of sensory feedback (e.g., visual feedback, auditory feedback, or haptic feedback); and may receive input from the user in any form (including acoustic input, voice input, or tactile input).

The systems and technologies described herein may be implemented in a computing system that includes a back-end component (for example, as a data server), or a computing system that includes a middleware component (for example, an application server), or a computing system that includes a front-end component (for example, a user computer with a graphical user interface or a web browser through which the user can interact with an implementation of the systems and technologies described herein), or any combination of such back-end component, middleware component, or front-end component. The components of the system may be interconnected by any form or medium of digital data communication (e.g., a communication network). Examples of communication networks include a local area network (LAN), a wide area network (WAN), and the Internet.

The computer system may include clients and servers. A client and server are generally remote from each other and typically interact through a communication network. The relationship of client and server arises by virtue of computer programs running on corresponding computers and having a client-server relationship to each other.

It should be understood that the various forms of processes shown above can be used to reorder, add, or delete steps. For example, the steps described in the present disclosure can be executed in parallel, sequentially, or in different orders, as long as the desired results of the technical solutions disclosed in the present disclosure can be achieved. This is no limited herein.

The above specific embodiments do not constitute a limitation to the protection scope of the present disclosure. It should be understood by those skilled in the art that various modifications, combinations, sub-combinations, and substitutions may be made according to the design requirements and other factors. Any modification, equivalent replacement, improvement, and the like made within the spirit and principle of the present disclosure should be included within the protection scope of the present disclosure.

What is claimed is:

1. A method for defending against an attacking behavior, the method being applied to defensive node devices, and a number of the defensive node devices being at least two, the method comprising:
receiving a signaling request sent by a terminal provided with an APP, the signaling request being used for requesting for establishing a trusted connection with the defensive node devices, and the signaling request at least including information of the terminal and the APP;
authenticating the terminal based on the information of the terminal and the APP, establishing, in response to the authenticating the terminal being successful, the trusted connection with the terminal, and forwarding APP traffic from the terminal to a source station of the APP; and
returning a dispatching instruction to the terminal, the dispatching instruction being used for instructing a defensive node device to which the terminal sends the signaling request a next time.

2. The method according to claim 1, wherein before the returning a dispatching instruction to the terminal, the method further comprises:
determining the defensive node device to which the terminal sends the signaling request the next time based on a defensive policy, wherein the defensive policy is used for dispatching between the at least two defensive node devices.

3. The method according to claim 2, wherein the determining the defensive node device to which the terminal sends the signaling request the next time based on a defensive policy comprises:
acquiring a current attack situation of each defensive node device; and
determining a current response performance of each defensive node device based on the attack situation, and determining the defensive node device to which the terminal sends the signaling request the next time based on a principle of balanced response performance.

4. The method according to claim 2, wherein the determining the defensive node device to which the terminal sends the signaling request the next time based on a defensive policy comprises:
acquiring a user level of the terminal, the user level being divided based on an APP service feature of a user; and
determining the defensive node device to which the terminal sends the signaling request the next time based on a corresponding relationship between the user level and a node level;
wherein the at least two defensive node devices are divided based on the node level.

5. The method according to claim 4, wherein the node level includes a high level and other levels except for the high level; and accordingly, in response to a current defensive node device that establishes the trusted connection with the terminal belonging to the high level, the method further comprises:
dispatching, in response to monitoring occurrence of an attacking behavior on a defensive node device of the high level, a terminal with the user level higher than a first set threshold among at least one terminal that establishes the trusted connection with the defensive node device of the high level to a backup defensive node device by returning the dispatching instruction.

6. The method according to claim 5, wherein in response to the current defensive node device that establishes the trusted connection with the terminal belonging to the other levels, the method further comprises:
dispatching, in response to monitoring occurrence of an attacking behavior on a defensive node device of the other levels, a terminal with the user level lower than a second set threshold among at least one terminal that establishes the trusted connection with the defensive node device of the other levels to a highly defensive node device by returning the dispatching instruction;
wherein a response performance of the highly defensive node device is higher than response performances of other defensive node devices.

7. The method according to claim 6, wherein the highly defensive node device is further configured to dispatch a terminal with a trusted connection duration reaching a preset duration threshold to a defensive node device allocated to the terminal with the trusted connection duration reaching the preset duration threshold last time by the dispatching instruction.

8. The method according to claim 6, wherein the highly defensive node device is further configured to establish the trusted connection with a terminal starting the APP for a first time.

9. The method according to claim 1, wherein the dispatching instruction comprises an address of the defensive node device to which the terminal sends the signaling request the next time, and time when the terminal sends the signaling request the next time;
wherein, before the time comes, the terminal establishes the trusted connection with the current defensive node device.

10. A method for defending against an attacking behavior, the method being applied to a terminal provided with an APP, the method comprising:
sending a signaling request to defensive node devices, a number of the defensive node devices being at least two, the signaling request being used for requesting for establishing a trusted connection with the defensive node devices, and the signaling request at least including information of the terminal and the APP;
establishing, in response to the defensive node devices successfully authenticating the terminal based on the information of the terminal and the APP, the trusted connection with the defensive node devices, and forwarding APP traffic of the terminal to a source station of the APP by the defensive node devices; and
determining, based on a dispatching instruction returned by the defensive node devices, a defensive node device to which the signaling request is sent a next time.

11. The method according to claim 10, wherein before the sending a signaling request to defensive node devices, the method further comprises:
acquiring, in response to starting the APP, an address of the defensive node devices by a domain name resolution server;
wherein the domain name resolution server is configured to allocate a defensive node device to the terminal through domain name resolution, the defensive node device is a highly defensive node device, and a response performance of the highly defensive node device is higher than response performances of other defensive node devices.

12. The method according to claim 11, wherein the dispatching instruction comprises an address of the defensive node device to which the terminal sends the signaling request the next time, and time when the terminal sends the signaling request the next time;
wherein, before the time comes, the terminal establishes the trusted connection with a current defensive node device.

13. An apparatus for defending against an attacking behavior, the apparatus being provided in defensive node devices, and a number of the defensive node devices being at least two, the apparatus comprising:
at least one processor; and
a memory storing instructions, wherein the instructions when executed by the at least one processor, cause the at least one processor to perform operations, the operations comprising:
receiving a signaling request sent by a terminal provided with an APP, the signaling request being used for requesting for establishing a trusted connection with the defensive node devices, and the signaling request at least including information of the terminal and the APP;
authenticating the terminal based on the information of the terminal and the APP, establishing, in response to the authenticating the terminal being successful, the trusted connection with the terminal, and forwarding APP traffic from the terminal to a source station of the APP; and
returning a dispatching instruction to the terminal, the dispatching instruction being used for instructing a defensive node device to which the terminal sends the signaling request a next time.

14. An apparatus for defending against an attacking behavior, the apparatus being provided in a terminal provided with an APP, the apparatus comprising:
at least one processor; and
a memory storing instructions, wherein the instructions when executed by the at least one processor, cause the at least one processor to perform operations, the operations comprising:
sending a signaling request to defensive node devices, a number of the defensive node devices being at least two, the signaling request being used for requesting for establishing a trusted connection with the defensive node devices, and the signaling request at least including information of the terminal and the APP;
establishing, in response to the defensive node devices successfully authenticating the terminal based on the information of the terminal and the APP, the trusted connection with the defensive node devices, and forwarding APP traffic of the terminal to a source station of the APP by the defensive node devices; and
determining, based on a dispatching instruction returned by the defensive node devices, a defensive node device to which the signaling request is sent a next time.

15. A non-transitory computer readable storage medium storing a computer instruction, wherein the computer instruction is used for causing a computer to execute the method according to claim 1.

16. A non-transitory computer readable storage medium storing a computer instruction, wherein the computer instruction is used for causing a computer to execute the method according to claim 10.
